(19) United States
(12) Patent Application Publication
(10) Pub. No.: US 2019/0178441 A1
(43) Pub. Date: Jun. 13, 2019

(54) CONVEYOR CONTROL COMPONENT MOUNTING

(71) Applicant: Dematic Corp, Grand Rapids, MI (US)

(72) Inventors: Daniel R. Bigelow, Grand Rapids, MI (US); Chad Brott, Howard City, MI (US); Samuel A. Sheffer, Rockford, MI (US); Randall J. Carlson, Grand Rapids, MI (US)

(21) Appl. No.: 16/144,022

(22) Filed: Sep. 27, 2018

Related U.S. Application Data
(60) Provisional application No. 62/566,883, filed on Oct. 2, 2017.

(51) Int. Cl. F16M 13/02; B65G 43/00; B65G 41/00

(52) U.S. Cl. CPC F16M 13/022; B65G 41/00; B65G 43/00

(57) ABSTRACT

A conveyor system, control assembly used with the conveyor system, and method of assembling a control assembly to a member made of ferromagnetic material. The control assembly has a control housing that houses at least one control component that is adapted to perform a control function. A support mechanism supports the control housing with the member. The support mechanism includes at least one permanent magnet mounted at a surface of the control housing that is adapted to attract the housing to the ferromagnetic material and a positioning feature. The positioning feature resists movement of the housing with respect to the member. The positioning feature may be adapted to resist movement of said housing with respect to the member in at least one degrees of freedom and perhaps in at least two degrees of freedom.

### BACKGROUND OF THE INVENTION

The present invention is directed to a technique for mounting a control component to a conveyor and, in particular, to mounting a control component to the side-channel of the conveyor. Conveyors are difficult to assemble. There are small spaces that are difficult to access with tools, and the conveyor defines a rugged operating environment that requires robust assembly to avoid the need for frequent maintenance. Various assembly techniques use mechanical fasteners. These can be difficult to attach especially with the difficulty of accessing small spaces.

### SUMMARY OF THE INVENTION

The present invention overcomes the difficulties associated with the use of permanent magnets to mount control components to a conveyor side-channel. In particular, the present invention recognizes that permanent magnets are good at attracting a housing to a ferromagnetic member, but have drawbacks that have prevented their use in the rugged environment of a conveyor. While the invention is illustrated for use in mounting a control component to a side-channel of the conveyor, it should be understood that it is useful for mounting to any ferromagnetic portion of the conveyor.

A conveyor system, control assembly used with the conveyor system, and method of assembling a control assembly to a member made of ferromagnetic material, according to an aspect of the invention, includes the control assembly having a control housing that houses at least one control component that is adapted to perform a control function. A support mechanism supports the control housing with the member. The support mechanism includes at least one permanent magnet mounted at a surface of the control housing that is adapted to attract the housing to the ferromagnetic material of the member and a positioning feature. The positioning feature resists movement of the housing with respect to the member.

The ferromagnetic material may be a side rail of the conveyor system having a pair of spaced apart longitudinally extending side-channels and a conveying surface between said side-channels. The support mechanism may include a stem that extends from the housing through an opening in the side-channel and a positioning plate that has a cutout that is configured to resist rotation of the stem with respect to the positioning plate when in the cutout. The positioning plate may include at least one other permanent magnet mounted at a surface thereof that is adapted to attract the plate to the side-channel. This resists rocking of the control housing along the length of the stem. The positioning plate may be mounted to a surface of the side-channel that is opposite to the surface supporting the control housing. The side-channel may have a bend adjacent the side-wall opening and the positioning plate is configured to engage the bend. This resists rotation of the positioning plate and therefore rotation of the housing about the stem.

The positioning plate may define at least one pocket adjacent a surface of the positioning plate and the another permanent magnet is in the at least one pocket. The control housing may include at least one pocket adjacent the control housing surface and the at least one permanent magnet is in the at least one pocket. The at least one permanent magnet and said another permanent magnet may each be a plurality of distributed bar magnets. The bar magnets may be made at least partially of cobalt.

The positioning feature may include a recess formed in said surface of the control housing with the recess sized to receive an extension from the side-channel. The extension from the side-channel may be a portion of a mounting bracket. The mounting bracket may support another control assembly. The another control assembly may be mounted at a surface of the side-channel that is opposite to the surface supporting the control housing. The conveying surface may be defined by belt-driven rollers and the another control assembly including a pneumatic actuator assembly that is adapted to selectively pressure the belt against some of the rollers. The mounting bracket may be supported in an opening in the side-channel and the extension is opposite the another control assembly.

The recess may be substantially a same shape as the extension. The recess may be substantially rectilinear. A grasping flange may defined in the control housing to facilitate separation of the control housing from the side-channel.

A conveyor system, control assembly used with the conveyor system, and method of assembling a control assembly to a side rail of the conveyor system, according to an aspect of the invention, includes a pair of spaced apart longitudinally extending side-channels, formed of a ferromagnetic material, and a conveying surface between the side-channels. A control assembly is supported by one of the side-channels. The control assembly has a control housing that houses at least one control component that performs a control function. A support mechanism supports the control housing with one of said side-channels. The support mechanism includes at least one permanent magnet mounted at a surface of the control housing that is adapted to attract the housing to a side-channel and a positioning feature. The positioning feature resists movement of the housing with respect to the side-channel in at least one degree of freedom. The positioning feature may be adapted to resist movement of said housing with respect to the side-channel in at least two degrees of freedom.

These and other objects, advantages and features of this invention will become apparent upon review of the following specification in conjunction with the drawings.

### BRIEF DESCRIPTION OF THE DRAWINGS

FIG. 1 is a side elevation view of a control assembly according to an embodiment of the invention mounted to a side-channel as viewed from the direction of the conveying surface;

FIG. 2 is a sectional view taken along the lines II-II in FIG. 1;

FIG. 3 is a perspective view of the control assembly mounted to a side-channel taken in the same general direction as in FIG. 1;

FIG. 4 is another perspective view of the control assembly mounted to a side-channel taken from the direction away from the conveying surface;

FIG. 5 is a perspective view taken generally from the front of the control assembly according to an embodiment of the invention;

FIG. 6 is an elevation view taken from the front of the control assembly in FIG. 5;

FIG. 7 is a perspective view taken generally from the rear of the control assembly in FIG. 5;

FIG. 8 is an exploded perspective view of the control assembly in FIG. 5, illustrating the support mechanism;

FIG. 9 is a perspective view of an alternative embodiment of an assembly mounted to a side-channel.

FIG. 10 is a side elevation view of the control assembly in FIG. 9 mounted to the side-channel as viewed from the direction away from the conveying surface;

FIG. 11 is a sectional view taken along the lines XI-XI in FIG. 10;

FIG. 12 is a perspective view of the control assembly in FIG. 9 taken generally from the rear surface that faces the side-channel;

FIG. 13 is an elevation view of the control assembly in FIG. 12 taken from the rear surface;

FIG. 14 is a top plan view of the control assembly in FIG. 13;

FIG. 15 is an exploded perspective view of the control assembly in FIG. 12 illustrating the support mechanism; and

FIG. 16 is a perspective view of a conveyor system used with the invention with one side-channel and the rollers defining the conveying surface removed to illustrate internal details thereof.

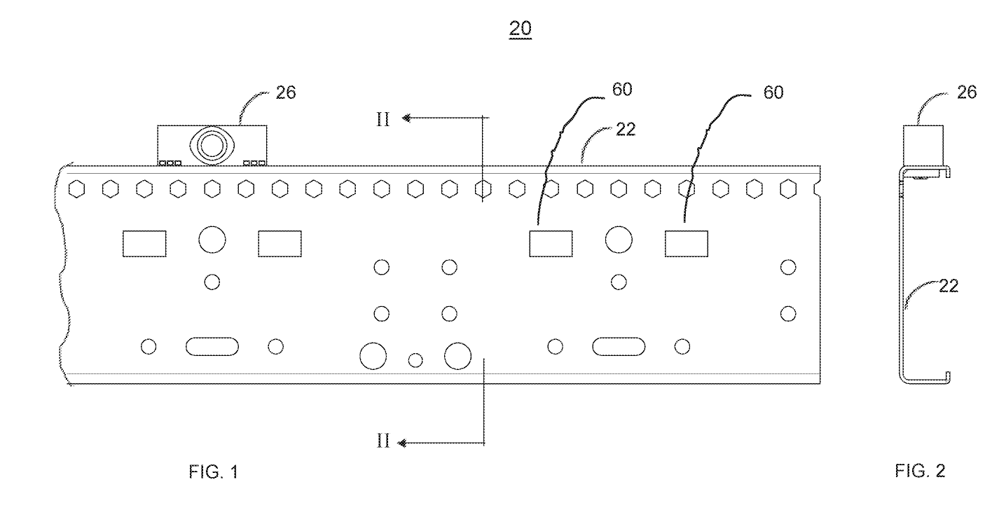

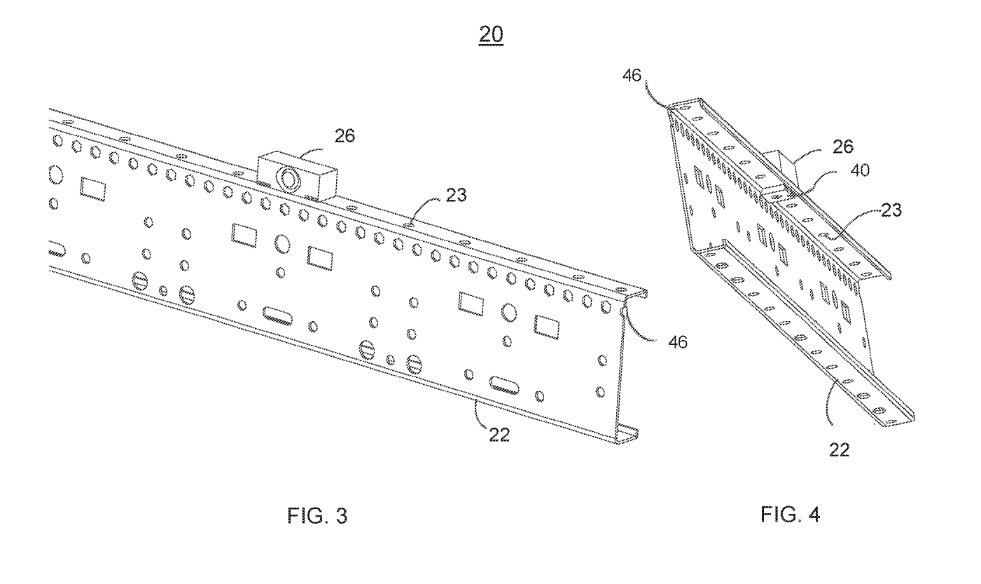

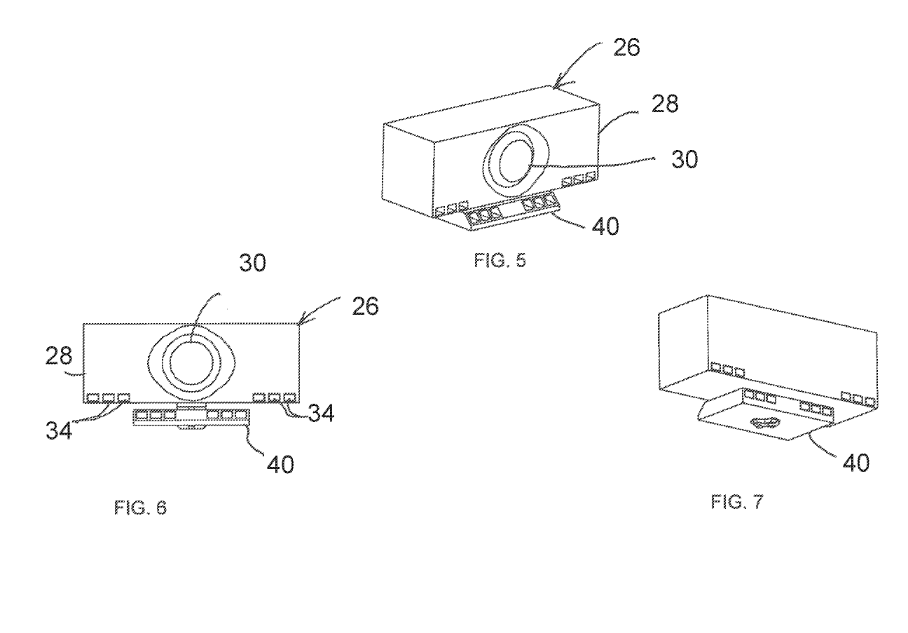

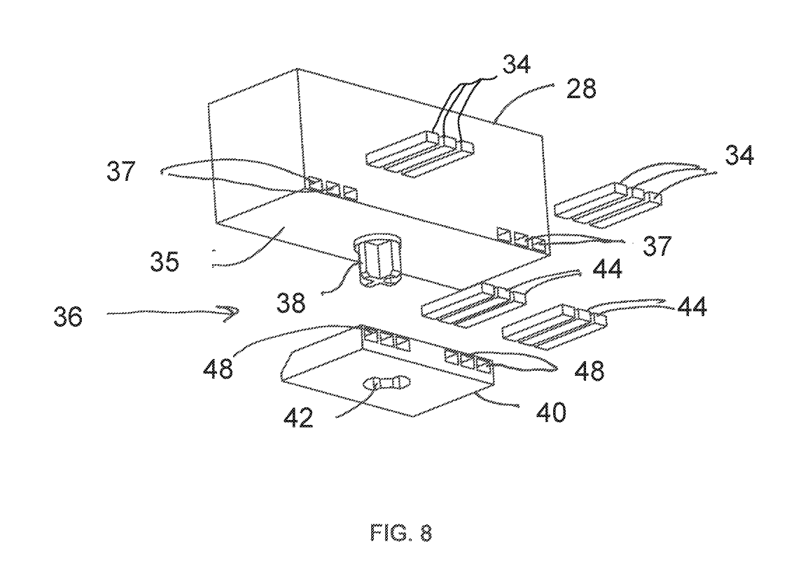

### DETAILED DESCRIPTION OF THE PREFERRED EMBODIMENT

Referring now to the drawings and the illustrative embodiments depicted therein, a conveyor system 20 includes a pair of spaced apart longitudinally extending side-channels 22, only one of which is shown in FIG. 16, and a conveying surface 24 between said side-channels 22 defined by rollers (not shown) that are driven from below by a driven belt 64. It should be understood that the invention can be embodied in other forms of conveying surfaces including, belt, segmented-belt-on-roller (SBOR), motorized rollers, and the like. Side rails 22 are formed of a ferromagnetic material such as steel, which is capable of attracting a permanent magnet. Conveyor system 20 includes a control assembly 26 supported by one side-channel 22. Control assembly 26 has a control housing 28 that houses at least one control component 30 that is adapted to perform a control function. In the illustrated embodiment, control component 30 is a photo eye made up of a light-emitting laser diode, power supply, and logic circuitry for detecting an object being conveyed by conveying surface 24. However, control component 30 may include an electronic logic controller, a pneumatic logic controller, or a combination of the two. Thus, the term control component is intended to be broadly interpreted to include any component used in a control function including laser reflectors, indicators, and the like.

Control assembly 26 further includes a support mechanism to support control housing 28 with one of side-channels 22. The support mechanism includes at least one permanent magnet 34 mounted at a surface 35 of control housing 28 that is adapted to attract housing 28 to a side-channel 22 and a positioning feature 36 that is adapted to resist movement of control housing 28 with respect to the side-channel 22. In the illustrated embodiment, permanent magnet 34 is made up of a plurality of individual bar magnets that are distributed across surface 35 within recesses 37. Recesses 37 retain the bar magnets in place with little or no adhesive and separate the bar magnets from surface 35. However, permanent magnet 34 could alternatively be one or more larger planar magnets as are known in the art.

Control assembly 26 has a stem 38 that extends from housing 28 through an opening 23 in the side-channel and a positioning plate 40 that has a cutout 42 that is configured to resist rotation of stem 38 with respect to plate 40 when stem 38 is in cutout 42. This allows positioning plate 40 to establish rotational position of housing 28. Also, opening 23 can be a conventional circular opening and does not need to be specially formed to fit stem 38. Positioning plate 40 includes at least one other permanent magnet 44 mounted at a surface thereof, so that positioning plate is mounted to a surface of side-channel 22 that is opposite to the surface supporting the control housing. In this manner, permanent magnet 44 is adapted to attract plate to the side-channel 22 and does not create magnetic attraction between housing 28 and positioning plate 40. In the illustrated embodiment, permanent magnet 44 is formed of a plurality of bar magnets that are fixedly retained in recesses 48 that are distributed about plate 40, but could be other shapes as well. Positioning plate 40 is positioned at a bend 46 in side rail 22. This restrains positioning plate 40 from rotating about an axis defined by stem 38. Thus, with positioning plate 40 against bend 46, control housing 28 is resisted from rotating about stem 38, and is thereby adapted to resist movement of the housing with respect to the side-channel in at least one degrees of freedom. Also, positional plate 40 adds thickness to stem 38. This resists rocking of control housing 28 along the length of stem 38 which is toward and away from conveying surface 24. Thus, the support mechanism resists movement of the housing with respect to the side-channel in another degrees of freedom.

Thus, control assembly is firmly affixed to side rail 22. This is accomplished without the need for fasteners, which would be difficult to thread onto stem 38 and rotate in the tight spaces within side-channel 22. Also, since fasteners tend to be made of plastic, they can only be hand tightened or risk damage to the fastener or the stem. It should be understood that control and/or power wires leading to control component 30 can extend through an opening (not shown) in stem 38 and cutout 42. In the illustrated embodiment, the bar magnets that define permanent magnets 34 and 44 are made at least partially of cobalt, or rare earth element, which are compact for the field they generate, but could be made of magnetized iron or other conventional material.

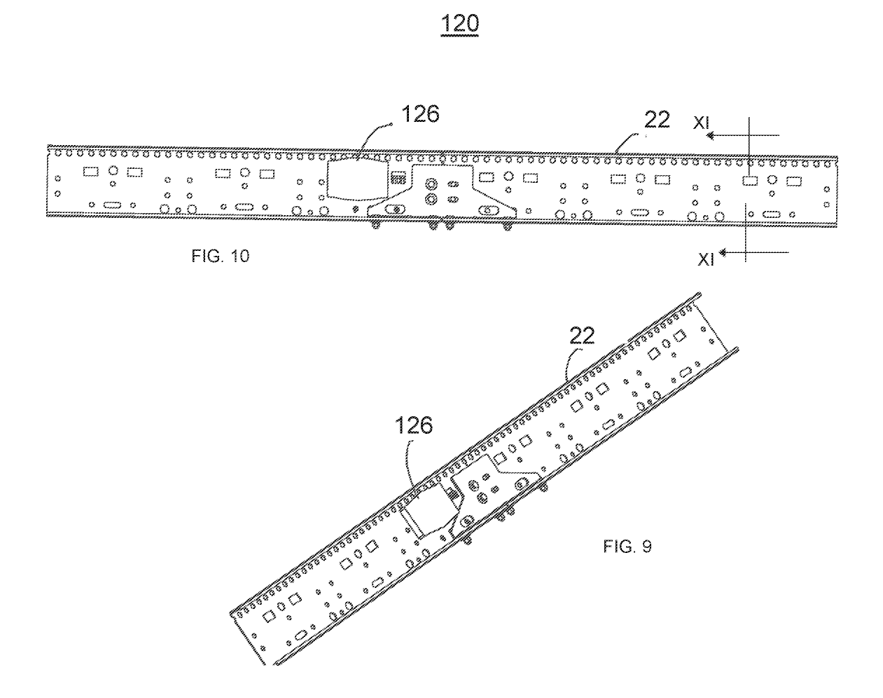

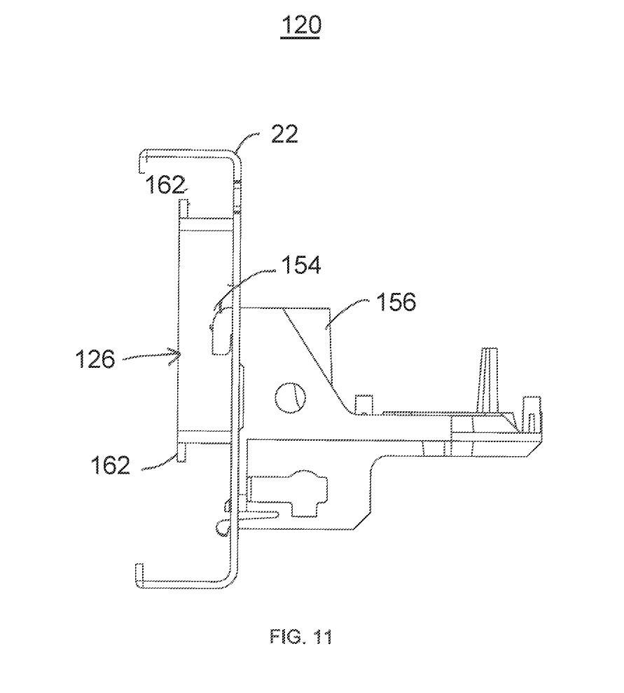

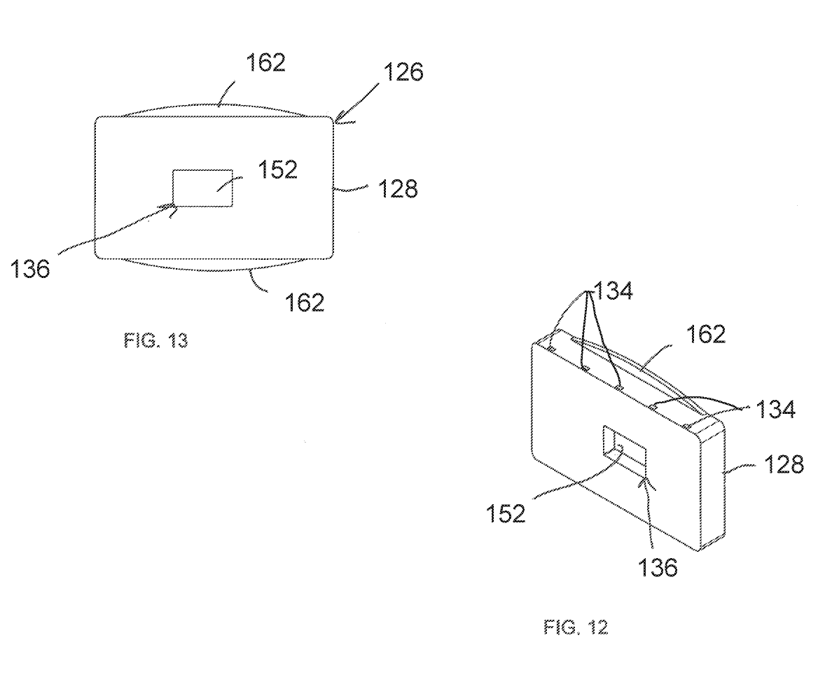

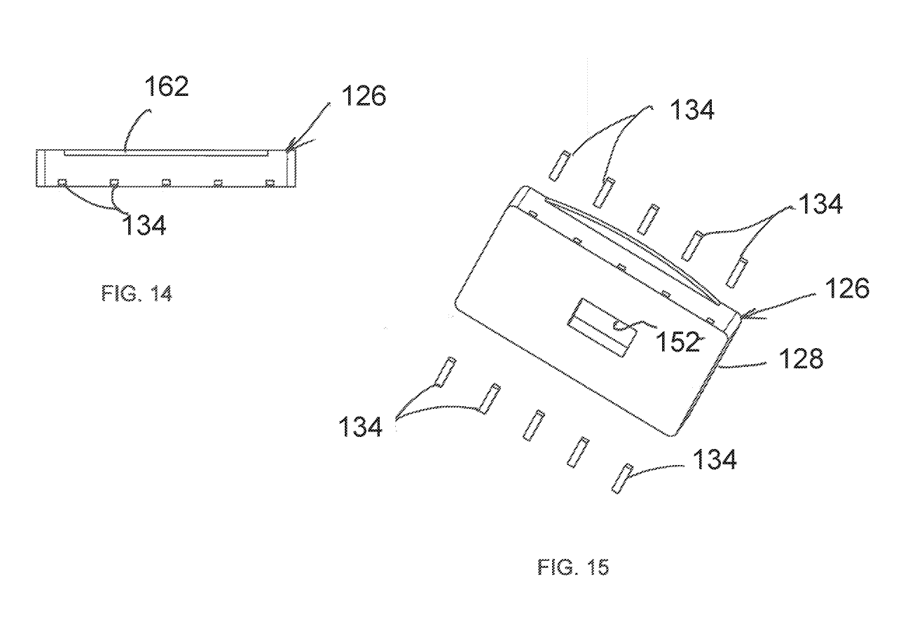

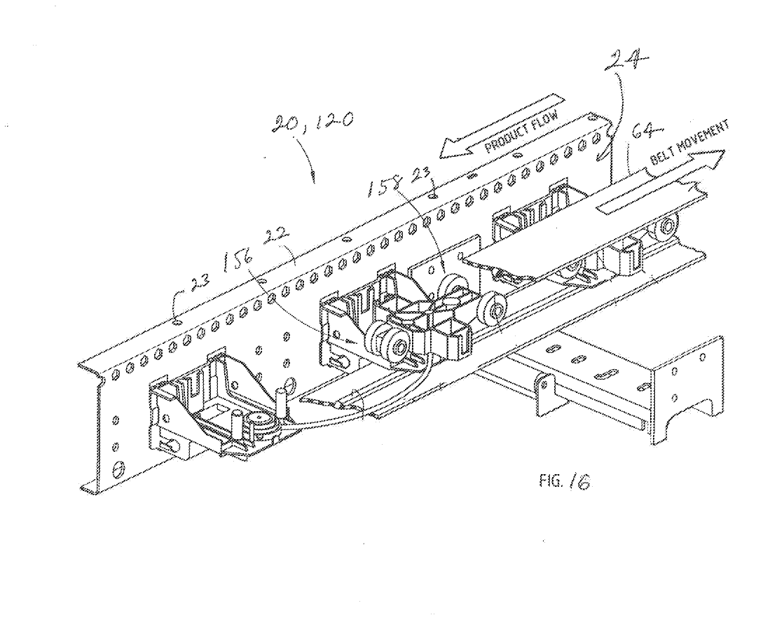

An alternative embodiment of a conveyor system 120 includes a control assembly 126 includes a housing 128 and interval control components that are not visible through housing 128 and at least one permanent magnet 134 that attracts housing 128 to side-channel 22. Control assembly 126 further includes a positioning feature 136 that is adapted to resist movement of control housing 128 with respect to the side-channel 22 (FIGS. 9 through 15). Positioning feature 136 is made up of a recess 152 formed in a surface of control housing 128 that faces side-channel 22. Recess 152 sized to receive an extension 154 from side-channel 22. Thus, positioning feature 136 is adapted to resist movement of housing with respect to the side-channel in at least one degree-of-freedom, namely against the force of gravity and a second degree of freedom, namely longitudinally along the side-channel. The permanent magnet attracts the housing against the side-channel.

Extension 154 is a portion of a mounting bracket 156. Mounting bracket 156 supports another control assembly 158. In the illustrated embodiment, another control assembly 158 and its mounting bracket 156 are mounted to a surface of side-channel 22 that is below conveying surface 24, and therefore opposite to the surface supporting control housing 128. In particular, extension 154 is one of two hook shaped portions of mounting bracket 156 that engage openings 60 in side-channel 22 to support mounting bracket 156. Both extension 154 and recess 152 are substantially the same shape and are rectilinear. However, the shape of recess 152 is dictated by the shape of extension 154.

Thus, control assembly 126 can be held in position against a vertical wall of side-channel 22 just by using existing features of conveyor system 120. In this manner, no new holes need to be formed in the side channel and the control assembly 126 can be mounted by placing the housing 128 over existing extension 154 and allowing the permanent magnet 134 to attract the housing to the side-channel and the positioning feature 136 to resist downward or side-to-side motion of control assembly 126 with respect to the side-channel. Thus, a strong mounting is obtained without mechanical fasteners and without adding openings to the side-channel. This not only makes assembly easy but is also field assembly backward compatible with existing equipment. Grasping flanges 162 are shown on housing 128 in order to facilitate separation of control housing 128 from the side-channel by grasping the flanges.

In the illustrated embodiment another control assembly 158 is a pneumatic actuator assembly that is adapted to selectively pressure belt 64 against some of the rollers defining conveying surface 24. Control assembly 126 is an electronic/pneumatic control that connects with an electronic network and provides pneumatic signals to operate another control assembly 158. Control assembly 158 is disclosed in more detail in commonly assigned U.S. Pat. No. 6,478,142 entitled CONTACT ASSEMBLY FOR ACCUMULATION CONVEYORS, the disclosure of which is hereby incorporated herein by referenced in its entirety.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

1. A conveyor system, comprising:
a member made of a ferromagnetic material;
a control assembly supported by the member, said control assembly having a control housing that houses at least one control component, said control component adapted to perform a control function;
a support mechanism to support said control housing with the member, said support mechanism comprising at least one permanent magnet mounted at a surface of said control housing that is adapted to attract said housing to the member and a positioning feature that is adapted to resist movement of said housing with respect to the member; and
a pair of spaced apart longitudinally extending side-channels formed of a ferromagnetic material and a conveying surface between said side-channels, wherein one of said side-channels comprises said member.

2. The conveyor system as claimed in claim 1 wherein said support mechanism comprises a stem that extends from said housing through an opening in the member and a positioning plate that has a cutout that is configured to resist rotation of said stem with respect to said plate when in said cutout.

3. The conveyor system as claimed in claim 2 wherein said plate includes at least one another permanent magnet mounted at a surface thereof that is adapted to attract said plate to the member.

4. The conveyor system as claimed in claim 2 wherein said positioning plate is mounted to a surface of the member that is opposite to the surface supporting the control housing.

5. The conveyor system as claimed in claim 2 wherein the member has a bend adjacent said side-wall opening and wherein said positioning plate is configured to engage said bend.

6. The conveyor system as claimed in claim 2 wherein said positioning plate defines at least one pocket adjacent a surface of said positioning plate and wherein said at least one other permanent magnet is in said at least one pocket.

7. The conveyor system as claimed in claim 1 including at least one pocket adjacent to said control housing surface and said at least one permanent magnet in said control housing at least one pocket.

8. The conveyor system as claimed in claim 1 wherein said at least one permanent magnet and said at least one other permanent magnet each comprise a plurality of distributed bar magnets.

9. The conveyor system as claimed in claim 8 wherein said bar magnets are made at least partially of cobalt.

10. The conveyor system as claimed in claim 1 wherein said positioning feature comprises a recess formed in said surface of said control housing, said recess sized to receive an extension from the member.

11. The conveyor system as claimed in claim 10 wherein extension from the member comprises a portion of a mounting bracket passing through the member.

12. The conveyor system as claimed in claim 11 wherein said mounting bracket supports another control assembly.

13. The conveyor system as claimed in claim 12 wherein said another control assembly is mounted at a surface of the member that is opposite to the surface supporting the control housing.

14. The conveyor system as claimed in claim 12 wherein said conveying surface is defined by belt-driven rollers and said another control assembly comprises a pneumatic actuator assembly that is adapted to selectively pressure said belt against some of said rollers.

15. The conveyor system as claimed in any of claim 11 wherein said mounting bracket is supported in an opening in said member and said extension is opposite said another control assembly.

16. The conveyor system as claimed in any of claim 10 wherein said recess is substantially a same shape as said extension.

17. The conveyor system as claimed in claim 16 wherein said recess is substantially rectilinear.

18. The conveyor system as claimed in claim 1 including a grasping flange defined in said control housing to facilitate separation of said control housing from the member.

19. A conveyor system, comprising:
a member formed of a ferromagnetic material;
a control assembly supported by said member, said control assembly having a control housing that houses at least one control component, said control component adapted to perform a control function;
a support mechanism to support said control housing with said member, said support mechanism comprising at least one permanent magnet mounted at a surface of said control housing that is adapted to attract said housing to a side-channel and a positioning feature that is adapted to resist movement of said housing with respect to the member in at least one degree of freedom; and
a pair of spaced apart longitudinally extending side-channels formed of a ferromagnetic material and a conveying surface between said side-channels, wherein one of said side-channels comprises said member.

20. A method of assembling a control assembly to a member of a conveyor system, the member formed of a ferromagnetic material, said method comprising:
having a control assembly with a control housing that houses at least one control component that is adapted to perform a control function; and
supporting said control housing with said member, said supporting including having at least one permanent magnet mounted at a surface of said control housing and attracting the housing to the member with the permanent magnet, and said supporting further including resisting movement of said housing with respect to the member with a positioning feature.
